(19) United States
(12) Patent Application Publication
(10) Pub. No.: US 2020/0026891 A1
(43) Pub. Date: Jan. 23, 2020

(54) RFID Communication and Validation System

(71) Applicant: VUEMED Inc., Seattle, WA (US)

(72) Inventors: Arnold Chazal, Naples, FL (US); Pavel Rozalski, Seattle, WA (US); Guy Russell, Seattle, WA (US)

(73) Assignee: VUEMED Inc., Seattle, WA (US)

(21) Appl. No.: 16/226,699

(22) Filed: Dec. 20, 2018

Related U.S. Application Data
(60) Provisional application No. 62/701,751, filed on Jul. 21, 2018.

(51) Int. Cl. G06K 7/10; G06K 19/07

(52) U.S. Cl. CPC G06K 7/10386; G06F 16/25; G06K 19/0723

(57) ABSTRACT

Various embodiments of communication and validation methods and systems using RFID components, systems and technology to implement wide-ranging applications. In an embodiment, a combination of one or more RFID tags detected by an RFID reader is communicated to a network server for comparison with a pre-programmed database of data, messages or instructions corresponding to various combinations of RFID tags. Upon matching the detected combination with its corresponding data, message or instruction, the network server communicates the data, message or instruction to at least one human interface device for review by a user of the system. An embodiment may be directed towards a system for inventory management by providing to users of the system an alert when the inventory levels for a specific product within a defined zone fall below a predetermined level and confirming said low stock alert within the defined zone by a secondary validation method. Another embodiment provides a system to observe qualitative and quantitative information concerning one or more living or inanimate subjects/objects, one or more states, conditions or characteristics thereof, or any such other states or conditions capable of quantitative or qualitative discernment through predetermined criteria established by users of the system.

### CROSS-REFERENCES TO RELATED APPLICATIONS

This application is the Non-Provisional application of Provisional Application No. 62/701,751 (Confirmation No. 6197), filed on Jul. 21, 2018 for “RFID COMMUNICATION AND VALIDATION SYSTEM” by Arnold Chazal, et al. This Non-Provisional application claims priority to and the benefit of that Provisional Application, the contents and subject of which are incorporated herein by reference in their entirety.

### STATEMENT REGARDING FEDERALLY SPONSORED RESEARCH OR DEVELOPMENT

Not Applicable

### BRIEF DESCRIPTION OF THE INVENTION

Embodiments of the invention are directed towards communication and validation methods and systems using RFID components and technology.

### BACKGROUND

Radio-frequency identification (RFID) is a commonly used tracking system that uses electromagnetic or radio (RF) fields to automatically identify and track tags attached to objects. RFID tags contain electronically-stored information and can be either “active” or “passive.” Two-way radio transmitter-receivers called “interrogators” or “readers” transmit an RF signal to the tag and read its response, i.e., the electronically-stored information within the tag, thereby identifying unequivocally the tag itself, since each tag is unique, and therefore tracking the object to which the tag has been attached (typically by way of software on a computer system or network server to which users of the tracking system have pre-associated the respective object to the unique tag attached to the object). RFID has many uses and is often utilized for tracking and maintaining inventory of product in a variety of circumstances.

Passive RFID systems use tags with no internal power source. Instead, passive tags collect and use the electromagnetic energy from the radio signal transmitted by a nearby RFID reader (hereinafter, while the synonymous terms “reader” and “interrogator” may be used interchangeably for the transmitter/receiver device that transmits an initiating or interrogating signal to be received by the RFID tag and receives the corresponding response signal back from the RFID tag, the term “reader” is used; to the extent the industry recognizes any differences between the terms, the term “reader” as used herein is specifically intended to include any such differences and comprise the meanings of both terms). Active tags, on the other hand, utilize an incorporated local power source, such as a battery. Active RFID tags periodically (or continuously) transmit their respective identification (ID) signal based on the electronically stored information therein. Alternatively, passive RFID tags are activated when in the presence of an RFID reader (and are powered by the reader's signal) and transmit their respective signal in response to the presence of an initiating reader transmission signal. An RFID tag need not be within the line of sight of the reader, so it may be applied to the surface of the object to be tracked or its packaging or embedded in the tracked object. As discussed further within, RFID systems using ultra-high frequency (UHF) transmission signals from the reader allow for the detection of passive RFID tags at much greater distances from the reader than High Frequency passive RFID technology.

Tags are identified either through their factory supplied serial number or a value set in the field that cannot be subsequently changed. Either value can be used to uniquely identify an RFID tag.

RFID tags contain at least three parts: an integrated circuit that stores and processes information and that modulates and demodulates radio-frequency (RF) signals; a means of collecting DC power from RF signal transmitted by the interrogating reader; and an antenna for receiving the reader's transmission signal and transmitting a response signal thereto (to be received and read by the reader). The unique tag information is stored in a non-volatile memory. The RFID tag includes either fixed or programmable logic for processing the transmission and sensor data, respectively, typically by means of a microchip or integrated circuit. (Discussed in detail below with reference to FIG. 1).

An RFID reader generally comprises: 1) a primary transmission/receiver portion for generating interrogating signals and reading response signals from an RFID tag, and 2) a signal antenna portion for transmitting and receiving the RF signals to and from RFID tags. (Discussed in detail below with reference to FIG. 1).

An RFID reader transmits an encoded radio signal to interrogate an RFID tag within range of its signal. The RFID tag receives the transmission signal from the reader and then responds with its unique identification code or serial number and other relevant data. Such other data may include, but is not limited to, product-related information such as a stock number, lot or batch number, production date, or other specific information. Importantly, since tags have individual, unique serial numbers, an RFID system design can discriminate among several RFID tags that might be within the range of the RFID reader, read them simultaneously, and distinguish between and among the multiple RFID tags comprising the system. As such, as discussed with respect to the various embodiments of the invention, the presence of one or more RFID tags, including various combinations of tags, read simultaneously by an RFID reader may be “decoded” or interpreted to mean any number of quantitative or qualitative indicia based on predetermined criteria established for the RFID system by the users of the system. (Discussed in detail below with reference to FIG. 2).

Fixed readers may be established to create specific, discrete interrogation zone(s) which can be tightly controlled. This allows a highly defined reading area for when RFID tags enter and leave the interrogation zone. Mobile readers may be hand-held or mounted on carts or vehicles.

Signaling between the reader and the RFID tag is done in several different ways, as is commonly known in the industry, depending, for example, on the frequency band used by the tag. Passive RFID tags 230 generally operate at three frequencies: 125-134 KHz or low frequency (LF), 13.56 MHz or high frequency (HF) and 865-960 MHz or ultra-high frequency (UHF). Tags operating on low frequency (LF) and high frequency (HF) bands are, in terms of radio wavelength, in relatively close proximity to the reader antenna. At ultra-high frequency (UHF) and higher frequencies, the RFID tag is typically further away from the reader. Active tags, on the other hand, may contain functionally separated transmitters and receivers, and the tag need not respond on a frequency related to the reader's interrogation signal.

Often more than one tag will respond to an RFID reader's signal. For example, many individual products with RFID tags may be shipped in a common box or on a common pallet. In such situations, RFID technology uses collision detection methods commonly known and used in the industry to allow reading of the data of multiple, numerous tags.

### SUMMARY OF THE INVENTION

The present invention comprises various embodiments of communication and validation methods and systems that use RFID components, systems and technology to implement wide-ranging applications. For example, as discussed in greater detail within, an embodiment may be directed towards an apparatus and system for inventory management by providing to users of the system an “alert” when the inventory levels for specific product within a defined zone have fallen below a predetermined level and confirming said low stock alert within the defined zone by a secondary validation method. As used herein, the term “zone” may comprise any predetermined or defined area, such as, but not limited to, product shelves or containers of all types, permanent or temporary displays, dump bins, racks, pegboards, counter-tops, dispensers, buildings, containers, or other compartments or areas, such as inventory storage areas, intended to hold product (inventory) temporarily or permanently. By way of another example, an embodiment of the invention provides systems and methods to observe qualitative and quantitative information concerning one or more living or inanimate subjects/objects, one or more states, conditions or characteristics thereof, or any such other states or conditions capable of quantitative or qualitative discernment through predetermined criteria established by users of the system (and any combination(s) of the foregoing). For example, with respect to an item such as a potted rose bush plant, an embodiment may be directed to communicate (and validate) such indicia as: 1) whether the plant is blooming, 2) whether the ambient temperature for the plant is optimum (according to predetermined criteria), or 3) whether the plant has been processed and is ready for shipment. These are but only a few examples of the wide-ranging applications for use with embodiments of the RFID communication and validation system presented.

### BRIEF DESCRIPTION OF THE DRAWINGS

FIG. 1 is a schematic drawing of an RFID system with one (1) RFID reader communicating with one (1) RFID tag.

FIG. 2 is a schematic drawing of an RFID reader communicating with multiple unique, individual RFID tags.

FIG. 3 is a schematic drawing of an embodiment of the invention depicting an RFID reader simultaneously communicating with multiple unique, individual RFID tags and with one or more network server(s) through a data/communication network, wherein said one or more network server(s) are pre-programmed with corresponding data, messages, instructions, alerts or other information corresponding to the presence and/or absence of the multiple RFID tags of the system (as detected by the reader) and further wherein, based on the presence and/or absence of said multiple RFID tags, the one or more network server(s) transmits said pre-determined data, messages, instructions, alerts or other information to one or more human interface devices according to the pre-programmed logic of the one or more network server(s).

FIGS. 4A-4C are schematic drawings of an embodiment of the invention depicting two RFID tags mounted adjacent to each other and a signal disruption element used to disrupt the receipt and transmission of RF signals by the RFID tags.

FIGS. 5A-5D are schematic drawings of an embodiment of the invention depicting three (3) RFID tags mounted adjacent to each other wherein each RFID tag further comprises a signal disruption element that may be used to disrupt the receipt and transmission of RF signals by the respective RFID tag.

FIG. 6 is sample table demonstrating various communications (by way of example only) that may be generated by various configurations of the three (3) RFID tag embodiment of FIGS. 5A-5D.

FIGS. 7A-7D are frontal perspective drawings of an embodiment of the invention comprising five (5) RFID tags mounted adjacent to each other and a single signal disruption element directed towards an inventory management system.

FIG. 8 is a schematic flow chart depicting a process implemented by an embodiment of the invention.

### FIGURE REFERENCES

These and other more detailed objects of the present invention will be disclosed when taken in conjunction with the following Detailed Description of the Invention in which like numerals represent like elements. The following is a listing of the reference numbers and the associated elements and features of embodiments as shown in the attached drawings:

Systems:

| | |
|---|---|
| 100 | System of a single RFID reader 210 communicating with a single |
| | RFID tag 230 |
| 200 | System of one or more RFID reader(s) communicating with |
| | multiple RFID tags 230 |
| 300 | System of one or more RFID reader(s) communicating with |
| | multiple RFID tags 230, wherein said one or more RFID reader(s) |
| | further communicate with at least one network server, 310, 320 |
| | (via a data/communication network), and wherein at least one |
| | network server(s) further communicates with at least one human |
| | interface device 330 (via a data/communication network). |

Components/Elements/Features:

| 24 | RFID signal disruption element | |
|---|---|---|
| | 24A | RFID disruption element hinge |
| 25 | RFID mounting element for mounting one or more RFID tags 230 with at | |
| | least one RFID communication disruption element 24 | |
| 99A | RFID initiating transmission (interrogating) signal from at least one RFID | |
| | reader 210 for receipt by one or more RFID tags 230 | |
| 99X | RFID response signal transmitted from one or more RFID tags 230 for | |
| | receipt by at least one RFID reader 210 | |
| 210 | RFID reader (for transmitting interrogating signal 99A and receiving | |
| | response signal 99X) | |
| 220 | Antenna to RFID reader | |
| 230 | RFID tag (either passive or active) | |
| | 231 | RFID tag 230 antenna |
| | 232 | RFID tag 230 microchip or integrated circuit |
| | 230A | First RFID tag 230 mounted adjacent to second RFID tag 230B |
| | 230B | Second RFID tag 230 mounted adjacent to first RFID tag 230A |
| | 230C | Third RFID tag 230 mounted adjacent to second RFID tag 230B |
| | 230D | Fourth RFID tag 230 mounted adjacent to third RFID tag 230C |
| | 230E | Fifth RFID tag 230 mounted adjacent to fourth RFID tag 230D |

| | |
|---|---|
| 302 | Data/communication network |
| 310 | One or more non-cloud-based network server(s) connected via |
| | data/communication network 302 to RFID reader 210 |
| 320 | One or more cloud-based network server(s) connected via |
| | data/communication network 302 to RFID reader 210 |
| 330 | One or more human interface devices connected via data/communication |
| | network 302 to one or more network server(s) 310, 320 |

The within description and illustrations of various embodiments of the invention are neither intended nor should be construed as being representative of the full extent and scope of the present invention. While particular embodiments of the invention are illustrated and described, singly and in combination, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited in any fashion. Rather, particular, detailed and exemplary embodiments are presented.

The images in the drawings are simplified for illustrative purposes and are not necessarily depicted to scale. To facilitate understanding, identical reference numerals are used, where possible, to designate substantially identical elements that are common to the figures, except that suffixes may be added, when appropriate, to differentiate such elements.

Although the invention herein has been described with reference to particular illustrative and exemplary physical embodiments thereof, as well as a methodology thereof, it is to be understood that the disclosed embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

### DETAILED DESCRIPTION OF THE INVENTION

A more detailed description of the invention now follows.

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of the more general classes. In general, use of any specific exemplar is intended to be representative of its class, and the non-inclusion of specific components (e.g., operations), devices, and objects should not be taken as limiting.

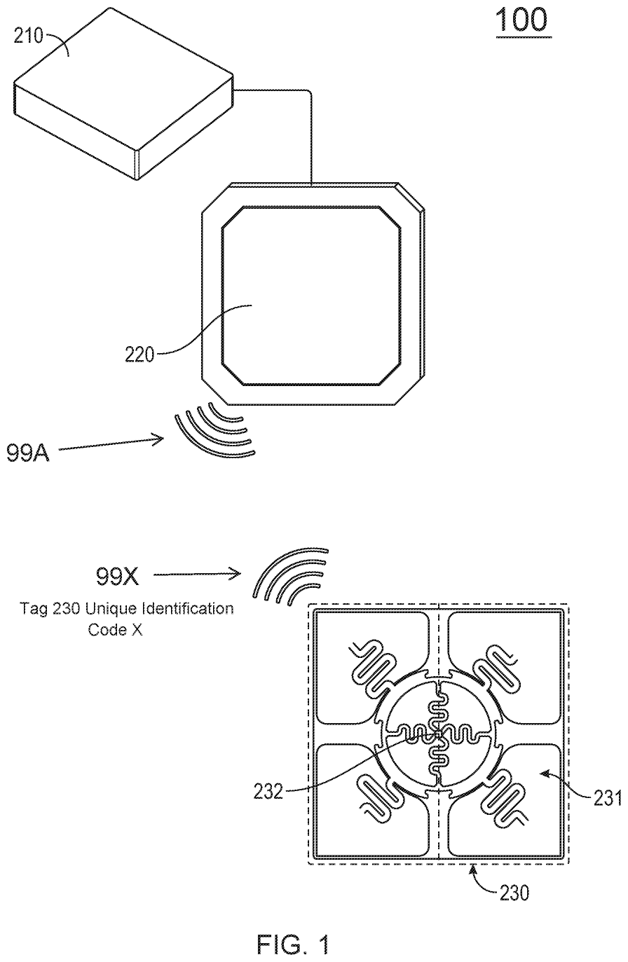

Referring to FIG. 1, generally, a passive RFID system 100 is depicted and is generally comprised of an RFID reader 210 (said reader 210 further comprising an RFID antenna 220) and at least one RFID tag 230. In embodiments of the invention, and referring to RFID system 100, it is preferred that a passive RFID system is used. Although the passive RFID system 100 of FIG. 1 is preferred, it should be noted that a person having ordinary skill in the art will appreciate that an active RFID system may also be utilized. Referring to FIG. 1, the passive RFID tag 230 is comprised of 1) an integrated circuit 232 that stores and processes information and that modulates and demodulates radio-frequency (RF) signals; 2) a means of collecting DC power from the RFID signal transmitted by the reader 210 (no reference number is utilized); and 3) and an antenna 231 for receiving the RFID signal 99A from the reader and transmitted a response signal 99X thereto back to the reader 210.

Continuing with FIG. 1, passive RFID tag 230 waits for a signal 99A from an RFID reader 210. RFID reader 210 sends energy to the RFID antenna 220 which converts that energy into an RF wave (signal 99A) that is transmitted therefrom and that is used to power the RFID tag 230. RFID antenna 231 receives the transmission signal 99A and draws in energy from the RF waves of the signal. The energy moves from the RFID antenna 231 to the integrated circuit 232 and powers the chip which, in turn, generates a return response signal 99X back to the RFID reader antenna 220 where the response signal 99X is received and detected by the RFID reader 210. The foregoing is well-known by ordinary persons skilled in the art and is intended to specifically include any variations thereof generally known in the art.

Importantly, RFID tag 230 comprises a unique identification code X that is transmitted from RFID tag 230 in its response signal 99X and received and read by reader 210. As a result, with the detection of RFID 230 by reader 210, the identification code X of RFID tag 230 is also detected and read by reader 210.

The identification code X of RFID tag 230 as comprised in embodiments of the invention, including RFID system 100, may be predefined or predetermined by users of the system to mean, equate to or be interpreted according to any specific indicia. For example, identification code X of RFID tag 230 may be assigned to a specific object or product and used for tracking said object or product. In such an example, when RFID tag 230 is attached to a specific object, if reader 210 receives and identifies identification code X, that would mean that the object to which tag 230 is attached is within range of and in the presence of the reader 210. In another example, identification code X of RFID tag 230 may be pre-determined by users of the system 100 to mean or indicate that a particular order of goods or product is ready for pickup and shipment to a buyer of those goods. In this example, receipt by reader 210 of signal 99X from RFID tag 230 wherein the unique identification code X thereof was predetermined to indicate that the particular order of product or goods is ready for pickup and shipment would mean exactly that—that the order of product or goods is in fact ready for pickup and shipment to the buyer of the goods. Contrarily, in the absence of unique identification code X, the order of the goods would not be ready for pickup and shipment and would remain in such state until such time that the receiver 210 receives the requisite identification code X from RFID tag 230. As such, as discussed with respect to the various embodiments of the invention, the presence of one or more tags 230, including various combinations of tags 230, read simultaneously by one or more reader(s) 210 may be “decoded” or interpreted to mean, equate to or indicate any number of quantitative or qualitative indicia based on predetermined criteria established for the RFID system by the users of the system.

In an embodiment, the RFID communication system 100 operates in ultra-high frequency (UHF) range. Although the passive RFID communication system 100 of FIG. 1 operates in ultra-high frequency (UHF) range, it should be noted that a person having ordinary skill in the art will appreciate that the system may also be adapted to and utilized with other frequencies.

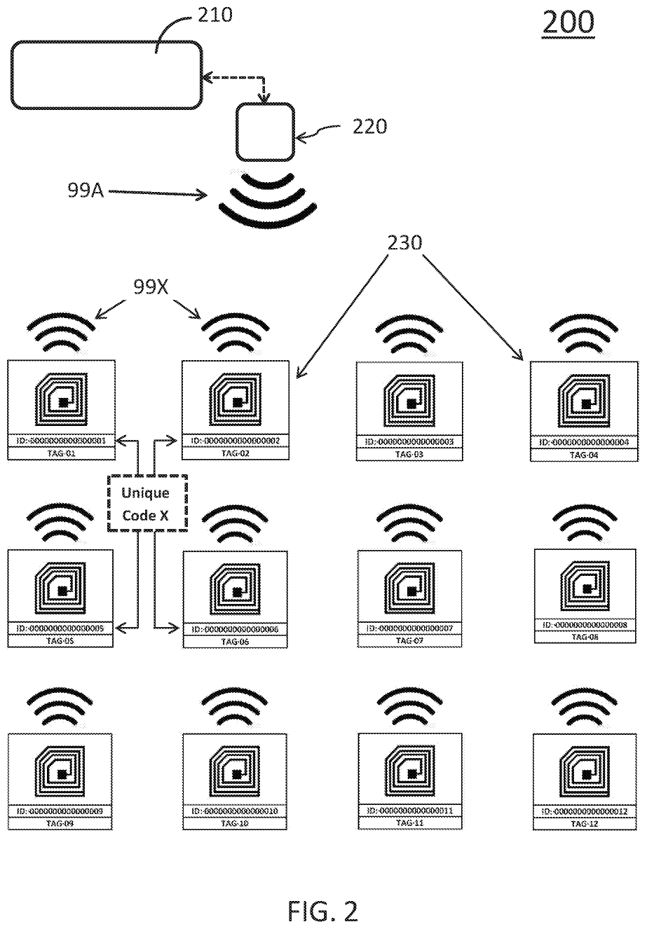

Referring to FIG. 2, an RFID communication system 200 is schematically depicted and comprises at least one RFID reader 210 and a plurality of passive RFID tags 230. In the embodiment of FIG. 2, twelve (12) unique RFID passive tags 230 are depicted (Tags-01 through -12), each RFID tag 230 with its own unique identification code X. Although the passive RFID system 200 of FIG. 2 represents a preferred embodiment, it should be noted that a person having ordinary skill in the art will appreciate that an active RFID system may also be utilized.

As with FIG. 1, passive RFID tags 230 of FIG. 2 remain inactive until transmission signal 99A from RFID reader 210 is detected by the respective tags 230. RFID reader 210 transmits initiating or interrogating signal 99A (through RFID antenna 220), of which said RF signal 99A is received by and used to power RFID tags 230. As described in FIG. 1, upon receipt of signal 99A by RFID tags 230, the tags generate and transmit respective response signals 99X thereto. The respective response signals 99X from RFID tags are received by reader 210 and each of the twelve (12) RFID tags 230 are detected by the reader 210.

Again, each of the twelve (12) RFID tags 230 of FIG. 2 comprises its own unique identification code X that is transmitted from the respective tag 230 in its return signal 99X and read by the reader 210. In the example depicted in FIG. 2, because each of the twelve (12) RFID tags 230 is detected and read by reader 210, the unique identification codes X of each tag 230 is also detected and read by reader 210.

As with the single tag example of FIG. 1, the identification codes X of each of the twelve (12) tags 230 of FIG. 2 may be pre-determined by users of the RFID system 200 to mean any desired indicia. By way of example, and by no means a limitation, the identification code X of tag 230 designated TAG-01 may be pre-determined by users of the RFID system 200 to mean that a shipment of a particular order of goods ABC is ready for pickup and shipment to a buyer of the goods; the identification code X of tag 230 designated TAG-02 may be pre-determined to indicate that a shipment of a particular order of goods DEF is ready for pickup and shipment; the identification code X of tag 230 designated TAG-03 may be pre-determined to indicate that a shipment of a particular order of goods GHI is ready for pickup and shipment, etc. In this example of FIG. 2, the receipt by reader 210 of the respective identification codes X of the three tags 230 designated TAG-01, TAG-02 and TAG-03 would indicate that the particular orders of goods ABC, DEF and GHI are all ready for pickup and shipment; in the absence of identification codes X from the three tags 230 designated TAG-01, TAG-02 and TAG-03, the orders of the goods predetermined and associated with each such identification code, i.e., goods ABC, DEF and GHI, would not be ready for pickup and shipment and would remain in such state until such time that reader 210 receives the requisite identification code X from each tag 230 associated with each order of goods. Again, as discussed with respect to the various embodiments of the invention, the presence of one or more tags 230, including various combinations of tags 230, read simultaneously by one or more reader(s) 210 may be “decoded” or interpreted to mean any number of quantitative or qualitative indicia based on predetermined criteria established for the RFID system by the users of the system.

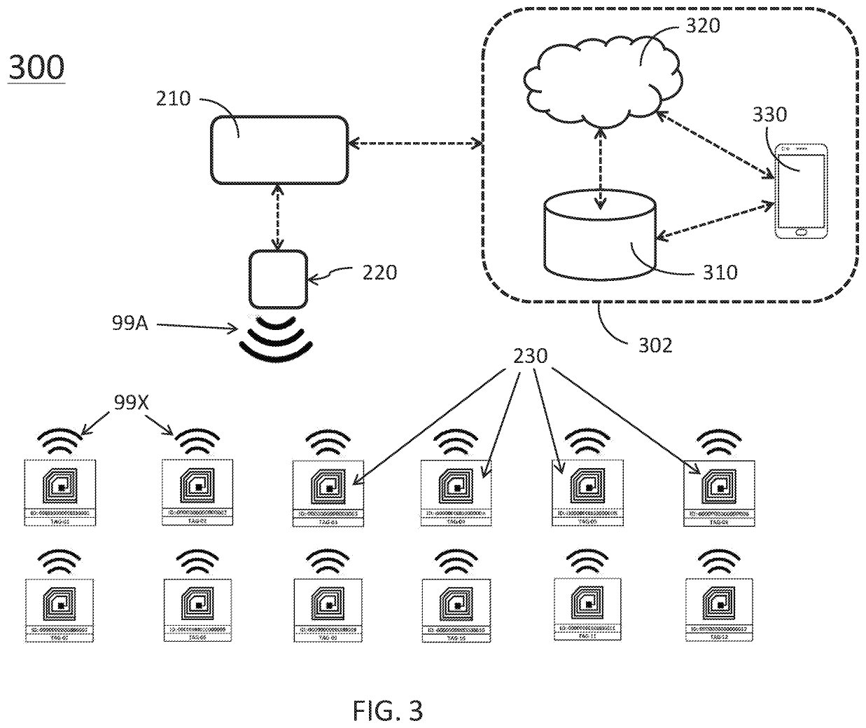

Referring to FIG. 3, an RFID communication system 300 is schematically presented as previously depicted in FIG. 2 with additional components. Referring to FIG. 3, an RFID communication system 300 is schematically depicted and comprises at least one reader 210 and a plurality of passive RFID tags 230. As with FIG. 2, twelve (12) unique RFID passive tags 230 are depicted (Tags-01 through -12) in FIG. 3, each tag 230 with its own unique identification code X. Although the passive RFID system 300 of FIG. 3 is preferred, it should be noted that a person having ordinary skill in the art will appreciate that an active RFID system may also be utilized.

Referring to FIG. 3, RFID reader 210 of system 300 communicates via RF signals with the twelve (12) RFID tags 230 as previously described with respect to FIGS. 1 and 2. In the system 300 of FIG. 3, the reader further communicates with at least one network server via a data/communication network 302. In the system 300 of FIG. 3, the network server may be discrete one or more dedicated server(s) 310 located either locally or remotely with respect to reader 210. The one or more network servers 310 communicate with reader 210 through the data/communication network 302 either wirelessly, through commonly known wired network hardware, systems and protocols, or any combination of the foregoing using WAN, WI-FI, LAN or any number of network protocols, systems and methods commonly known and used in the industry, without limitation as to any such specific means of communication. The network server comprising the data/communication network 302 may be further comprised of one or more cloud-based network servers 320, including, but not limited to, one or more virtual machines within one or more cloud-based network servers all remotely located from reader 210. RFID reader 210 may communicate with such one or more cloud-based network server(s) 320 via the data/communication network 302 either wirelessly, through commonly known wired network hardware, systems and protocols, or any combination of the foregoing using WAN, WI-FI, LAN or any number of network protocols, systems and methods commonly known and used in the industry, without limitation as to any such specific means of communication. Yet further, the one or more readers 210 of the embodiment of system 300 may communicate with any combination of local or remote dedicated, discrete server(s) 310 and/or one or more cloud-based network server(s) 320, again via any commonly known network communication protocols, systems and methods as used in the industry and well-known to those skilled in the art, and wherein, the one or more local or remote server(s) 310 may communicate with the one or more cloud-based network server(s) 320.

Continuing with the RFID communication system 300 of FIG. 3, the one or more network server(s) 310 and/or 320 may communicate via the data/communication network 302 with a user of the system through any number of human interface devices 330, such as computer work stations, smart phones, cell phones, tablets, mobile devices or any other human interface device that may be connected via commonly known network communication protocols to the one or more network server(s) 310 and/or 320 and capable of sending and/or receiving data to and from the one or more network server(s) 310 and/or 320.

In the RFID communication system 300 of FIG. 3, the one or more reader(s) 210 detects the respective response signals 99X of the one or more RFID tags 230 and reads the unique identification code X associated therewith as to each RFID tag 230. If a particular RFID tag 230 is not present, or, as described in greater detail below, if a particular tag's return signal 99X is not allowed to transmit, i.e., the signal 99X is blocked, then the respective RFID tag 230—and that tag's unique identification code X—is not read by the one or more reader(s) 210.

Upon receipt of a particular tag's return signal 99X—and the tag's unique identification code X—the reader 210 communicates the unique identification code X of each RFID tag 230 detected to the one or more network servers 310, 320. Referring to FIG. 3 (and the systems of all the figures made a part hereof), the one or more network server 310, 320 is further comprised of a processor (CPU) and a computer memory, as is commonly known in the art, capable of running a computer program or predetermined logic thereon (wherein the program may be stored in a computer readable medium of the one or more network servers 310, 320). When executed and running in an operational state on one or more network servers, said computer program or logic reads the unique identification code X of each tag 230 detected by reader 210 and communicated to one or more network servers 310, 320 via the data/communication network 302 and matches each such unique identification code X with its corresponding, predetermined message, code, instructions or other information or data, of which said message, code, instructions or other information or data may be accessed by the computer program from one or more databases comprising the at least one or more network servers 310, 320. The message, code, instructions or other information or data corresponding to each such unique identification code X is predetermined by user(s) of the system and entered into the one or more databases by user(s) through the interface devices 330 connected to the data/communication network 302, as described further within and is commonly understood and known by those of ordinary skill in the art (with respect to database compilation).

Referring to an example used with respect to FIG. 2, the unique identification code X of RFID tag 230 designated TAG-01 may be pre-determined and programmed into the program, logic or database running on the one or more network servers 310, 320 to indicate that the order of goods ABC is ready for pickup and shipment. Upon receipt of the unique identification code X for the tag 230 designated TAG-01 via the data/communication network 302, the one or more network server 310, 320 would match that unique identification code of TAG-01 with the predetermined instructions for that code, i.e., in this example, that the order of goods ABC is ready for pickup and shipment. That corresponding message or instruction (the order of goods ABC is ready for pickup and shipment) may then be communicated via the data/communication network 302 to a user of the RFID communication system through receipt by that user's interface device 330. Upon receipt of the corresponding predetermined instructions, the user of the communication from the one or more network server 310, 320 is thereby effectively advised that the order of goods ABC is ready for pickup and shipment. Of course, the above is just an example of the communication system of an embodiment of the invention and one skilled in the art would appreciate that the communication system is not limited to advising that an order of goods is ready for pickup and shipment. The message or instructions initiated by the one or more network servers 310, 320 and received by the user's interface device 330 may take any number of forms: email message, text or SMS (short messaging service) message, via smart device app customized for receipt of such messages, or any of other methods that are commonly known and used in the art for transmitting and receiving messages, alerts, notifications, instructions or other forms of data and communications.

Continuing with FIG. 3, equally as important as to which specific RFID tags 230 an RFID reader 210 detects are those RFID tags 230 that an RFID reader does not detect. Referring to the prior example concerning whether an order of goods is ready for pickup and shipment, it is only when the one or more reader(s) 210 detects a response signal 99X within a zone from the appropriate tag 230 matched with a corresponding set of instructions regarding the pickup and shipment of goods that corresponding set of instructions is communicated to a user or user's device 330. Unless and until the applicable unique identification code X of return signal 99X of a particular RFID tag 230 is detected by reader 210, the reader 210 will not communicate the identification code X associated with the RFID tag 230 to the one or more network server(s) 310, 320 and the one or more network server(s) 310, 320 will not transmit the corresponding set of instructions, messages, data, etc. to the user's device 330. As such, by interfering with or blocking the return signal 99X of a respective tag 230 (and, hence, preventing the transmission of the RFID tag's unique identification code X), the predetermined message, code, instructions or other information or data associated with the unique identification code X will not be transmitted. In the example regarding the shipment of goods, if the unique identification code X of the tag associated with the set of instructions indicating that the order is ready for pickup and shipment is intentionally blocked, then such order will be deemed not ready for pickup and shipment. Only when the return signal 99X is allowed to transmit from the tag 230 will the order be deemed ready for pickup and shipment. Of course, this is just one example, and the instructions for the tag configuration described may be predetermined by users of the system to mean the opposite: that the order is not ready for pickup and shipment.

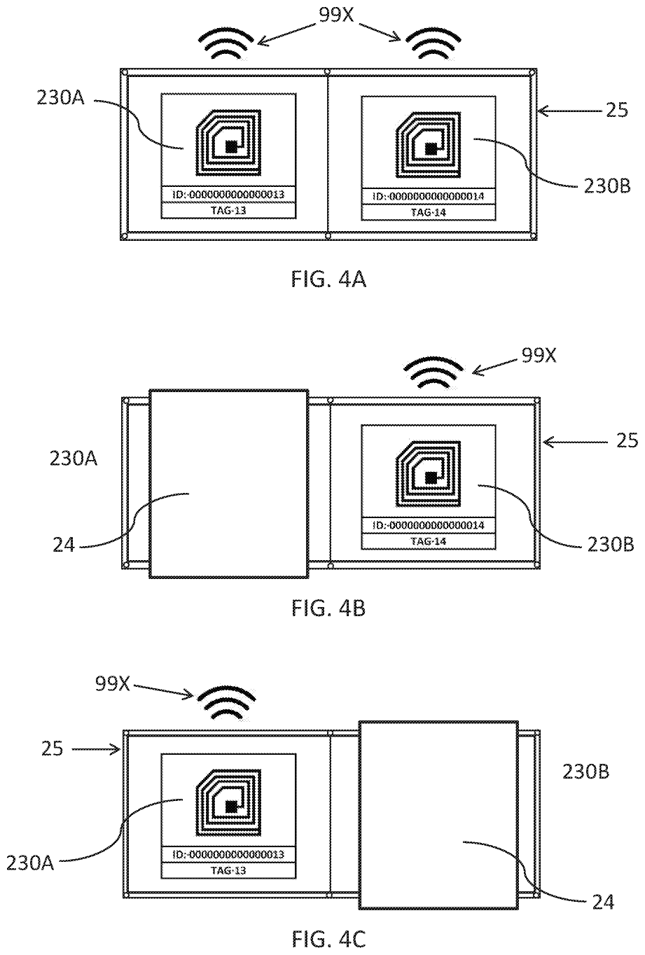

FIGS. 4A, 4B and 4C schematically depict the intentional blocking, prevention or disruption from transmission of a return signal 99X using an RFID signal disruption element 24. While the discussion addresses the blocking or disruption of a return signal 99X, with respect to passive RFID tags it should be noted that the initiating interrogating signal 99A from reader 210 is actually blocked or prevented from being received by RFID tag 230. As a passive RFID tag receives its energy and is powered by an RFID reader's transmission signal 99A, the RFID tag 230 is effectively prevented from generating and transmitting a responsive signal 99X as a result thereof. With respect to active or partially active RFID tags 230 that have an independent power or electrical source, such as a battery, and are therefore able to independently generate signals 99X, the blocking or disruption process, as immediately described, prevents any signal from being transmitted from the active or partially active RFID tag 230.

Referring to FIG. 4A, two passive RFID tags 230, a first RFID tag 230A and a second RFID tag 230B (respectively, for purposes of demonstration, designated TAG-13 and TAG-14) are mounted adjacent to each other on an RFID tag mounting element 25, which may comprise a holding plaque to allow for the easy detachable attachment of RFID tags as desired (such as with “hook and loop” (Velcro®) or other suitable means of easy detachable attachment). In addition, the use of detachable RFID tags 230 for placement or mounting on a mounting element 25 and physically visible signal disruption element(s) 24 presents a system or means of visible cues to user(s) of the system, as discussed further within. First RFID tag 230A and second RFID tag 230B are in range of an interrogating signal 99A of reader 210, and in response to the reader's transmission signal 99A, each tag transmits a simultaneous, but independent, response signal 99X to reader 210. Each tag is detected by reader 210 and the unique identification codes of first RFID tag 230A and second RFID tag 230B are received by reader 210 and may be further communicated to at least one network server 310, 320 in accordance with the above.

In FIG. 4B, a signal disruption element 24, in the form of a sliding shield in the depicted drawing, covers first RFID tag 230A, thereby preventing that passive RFID tag from receiving transmission signal 99A from reader 210 and preventing first RFID tag 230A from transmitting a response signal 99X thereto. Adjacent second RFID tag 230B, on the other hand, is not covered with a signal disruption element 24 and is able to receive transmission signal 99A from the reader 210. As a result, second RFID tag 230B is able to generate and transmit response signal 99X, which is detected by reader 210. Under the example of FIG. 4B, the unique identification code X of first RFID tag 230A is not received by reader 210, while the unique identification code X of second RFID tag 230B is received by reader 210 and may be further communicated to at least one network server 310, 320 in accordance with the above described process and system.

In FIG. 4C, a signal disruption element 24 covers second RFID tag 230B, thereby preventing that passive RFID tag from receiving transmission signal 99A from the at least one reader(s) 210 and, as a result thereof, further preventing second RFID tag 230B from transmitting a response signal 99X thereto. Adjacent first RFID tag 230A, on the other hand, is not covered with a signal disruption element 24 and is able to receive transmission signal 99A from reader 210. First RFID tag 230A is therefore able to generate and transmit a response signal 99X, which is detected by the at least one reader 210. Under the example of FIG. 4C, the unique identification code X of second RFID tag 230B is not received by reader 210, while the unique identification code X of first RFID tag 230A is received by reader 210 and may be further communicated to at least one network server 310, 320 in accordance with the above described process and system.

An RFID signal disruption element 24 may be comprised of any material and appropriate shape that acts as an effective RFID signal barrier to: prevent communication of RF signals between an RFID tag 230 and an RFID reader 210, prevent a passive RFID tag 230 from being powered by the RF signal 99A transmitted from reader 210, or any combination thereof. Such materials are readily known in the art and include, for example, various metals that are commonly known to disrupt, interfere with and/or block RF signals. An RFID signal disruption element 24 may take the form of a thin layer or shield of a suitable metal or any such other substance of sufficient dimensions (width and area) to effectively disrupt the receipt and transmissions of RF signals by the RFID tag 230. The embodiments of the invention disclosed and covered herein are not limited by the size, shape, format or material comprising a suitable RFID signal disruption element 24.

In addition, the use of the at least one RFID signal disruption element 24 with the disclosed embodiments is not limited to any particular means. The invention is specifically meant to encompass the placement of the at least one RFID signal disruption element 24 in any position about an RFID tag 230 to prevent or disrupt the receipt by and transmission of RF signals by the RFID tag 230. The at least one RFID signal disruption element 24 may be detachably attached to a single RFID tag 230 or may be movably attached for movable placement over a plurality of RFID tags 230 that are located adjacent or near each other.

In the embodiments depicted in FIG. 4B and FIG. 4C, the RFID signal disruption element 24 comprises a sliding, moveable “shield” mechanically attached to holder element 25, thereby allowing a user to slide the signal disruption element 24 over the desired tag (either first RFID tag 230A or second RFID tag 230B) in order to achieve the intended communication result. In an embodiment, multiple signal disruption elements 24 may be mechanically attached to one or more RFID tags 230 mounted or placed adjacent to each other, thereby allowing a user to block, prevent or disrupt RF signal communication involving one, multiple or none of the RFID tags comprising the system, depending on the various communication messages sought to be transmitted by way of response signals 99X from the accessible and detectable RFID tags 230. For example, referring to FIG. 4A, first RFID tag 230A and second RFID tag 230B of the embodiment may each have a signal disruption element 24 mechanically mounted to the tag by way of a hinge on the uppermost edge that would, for example, allow a user to flip a desired signal disruption element 24 over the top of the mounting unit 25 to cover the desired tag 230 at a desired time to achieve a desired result.

Importantly, by comprising and utilizing one or more signal disruption elements 24 at a defined location comprising one or more RFID tags 230, the various signal disruption elements 24 in use and on display may present visual cues to users of the system at that location. Not only do precise combinations of signal disruption elements provide unique communication codes or messages to the reader 210, and in turn, the at least one network server, but the combination of signal disruption elements 24 will display to users of the system visual cues that correspond to the predetermined code or messages associated with the combination of signal disruption elements 24 on display as discussed further within. As such, users of the system who have visible access to the combination of RFID tags 230 and signal disruption elements 24 on display therewith will be able to determine, based on a visual inspection of said combination, the predetermined code or messages associated with the combination, as accessed by the network server and communicated by the server to other (or the same) users of the system via the interface device 330.

Embodiments of the invention may also use a secondary communication as a basis for confirming a primary communication. Communications of embodiments of the RFID communication system are based not only on which specific RFID tags 230 are detected by the at least one reader 210, but also by which specific tags 230 are not detected by said reader(s) 210. Referring to FIG. 4B, for example, the absence of return signal 99X from first RFID tag 230A (i.e., the return signal 99X of first RFID tag 230A is not detected by reader 210) would be interpreted by the one or more network server(s) 310, 320 based on the predetermined programming as established by user(s) of the system to mean that a particular shipment of goods is not ready for pickup. This particular conclusion is validated and confirmed by the presence of return signal 99X from second RFID tag 230B (i.e., the return signal 99X of second RFID tag 230B with its unique code X is detected by reader 210), which would also be interpreted by the predetermined programming of the one or more network server(s) 310, 320 (or databases accessed therefrom, of which said predetermined programming may be input by user(s) via user interface devices 330) to also mean that the same particular shipment of goods is not ready for pickup. As such, in the embodiment of FIG. 4B, the absence of return signal 99X from first RFID tag 230A (and its corresponding message that the shipment is not ready for pickup) confirms and validates the presence of return signal 99X from second RFID tag 230B (and its corresponding message that the shipment is not ready for pickup) and vice versa. The absence of a first return RFID signal 99X confirms and validates the presence of a second return RFID signal 99X and the presence of the second return RFID signal 99X confirms and validates the absence of the first return RFID signal 99X.

Referring to FIG. 4C, the absence of return RFID signal 99X from second RFID tag 230B (i.e., the return signal 99X of second RFID tag 230B is not detected by reader 210) would be interpreted by the predetermined programming one or more network server(s) 310, 320 to mean that the particular shipment of goods is ready for pickup. This particular conclusion is validated and confirmed by the presence of the return signal 99X from first RFID tag 230A (i.e., the return signal 99X of first RFID tag 230A is detected by reader 210), which would also be interpreted by the predetermined programming of one or more network server(s) 310, 320 to also mean that the same particular shipment of goods is ready for pickup. As such, in the embodiment of FIG. 4C, the absence of return signal 99X from second RFID tag 230B (and its corresponding message that the shipment is ready for pickup) confirms and validates the presence of return signal 99X from first RFID tag 230A (and its corresponding message that the shipment is ready for pickup) and vice versa. The absence of a second return RFID signal 99X confirms and validates the presence of a first return RFID signal 99X and the presence of the first return RFID signal 99X confirms and validates the absence of the second return RFID signal 99X.

As demonstrated in FIGS. 4B-C, the embodiment disclosed therein works as a communication switching device with its own validation/confirmation mechanism. Either the order is not ready for shipment (described in the first scenario) or the order is ready for shipment (described in the second scenario), but not both. The signal disruption element 24 is manually moved or manipulated by a user to communicate an intended message via the system of 300 based on predetermined programming as to the detection or non-detection of response RFID signals 99X of first RFID tag 230A and 230B where said intended communication is ultimately received by one or more human interface devices 330 and read by one or more users. Referring to the embodiment of FIGS. 4B-C, should the one or more network server(s) 310, 320 receive communication(s) from the at least one RFID reader(s) that the return RFID signals 99X of both first tag 230A and second tag 230B are detected or that neither RFID signals 99X of both first tag 230A and second tag 230B are detected, the predetermined programming on the one or more network server(s) 310, 320 would generate an error message to users of the system since the switching function of the signal disruption element 24 is binary and either result is not permitted. Such situations may occur, for example, if the signal disruption element 24 partially covers both first RFID tag 230A and second RFID tag 230B, one or more of the subject RFID tags (230A and/or 230B) is not operating correctly, the one or more RFID reader(s) 210 is not operating properly, or any other technical issues or matters that would interfere with the proper transmission of RF signals to and from the RFID tags 230 and reader(s) 210 or the network data communication to and from the reader(s) 210 and the at least one network server(s) 310, 320 or the programming of said network servers.

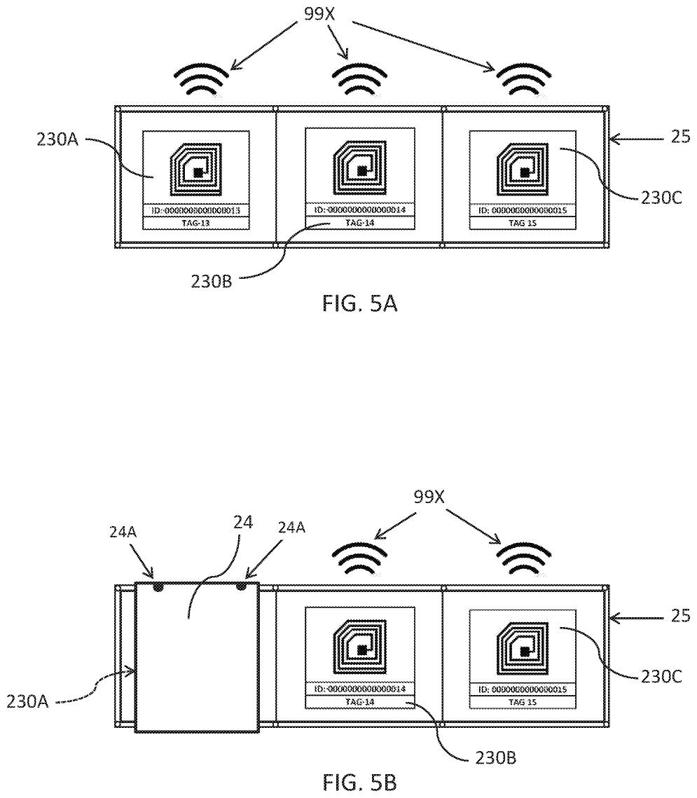

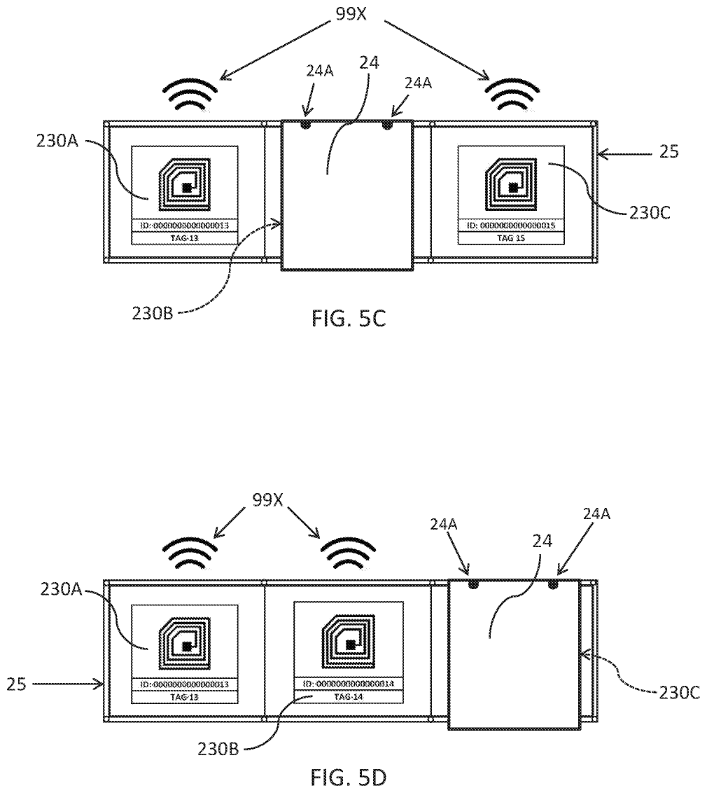

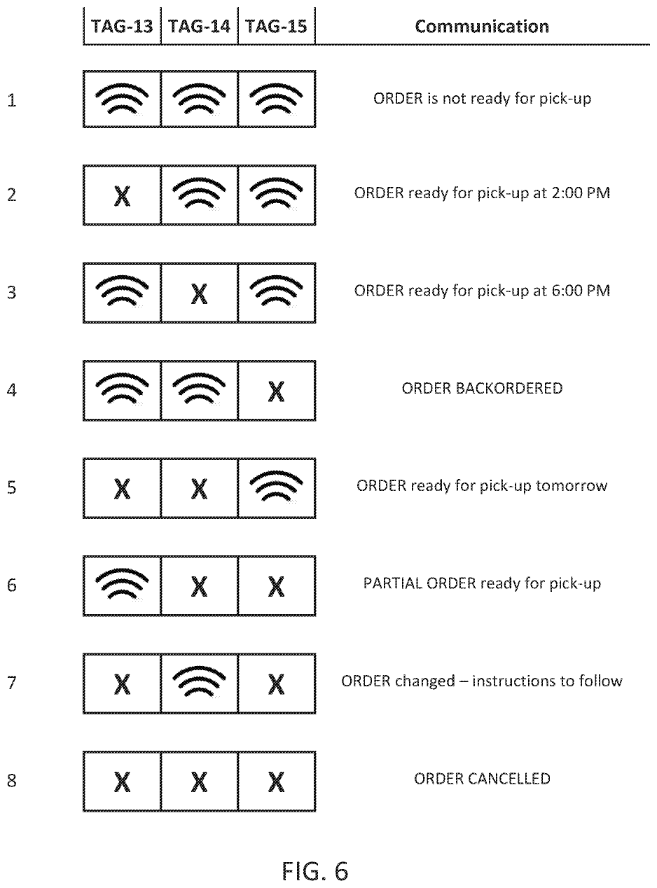

FIGS. 5A-5D depict an additional embodiment of the invention. The embodiment of FIGS. 5A-5D comprises three (3) RFID tags mounted adjacent to each other on a mounting or holding element 25: a first RFID tag 230A (designated TAG-13), a second RFID tag 230B (designated TAG-14) and a third RFID tag 230C (designated TAG-15). The three (3) RFID tags of FIGS. 5A-5D each has its own corresponding RFID signal disruption element 24 which may be manually moved or manipulated by a user to cover the corresponding RFID tag to which the signal disruption element 24 is attached or associated, thereby effectively preventing, disrupting or blocking the transmission of the RFID tag's 230 respective return signal 99X (and thus block the respective RFID tag's unique identification code X from being detected/read by the at least one reader 210 and thereby preventing communication of that code to the at least one network server(s) 310, 320). In the embodiment of FIGS. 5A-5D the RFID signal disruption element 24 for each RFID tag is mounted to the mounting element 25 via hinges 24A, thereby allowing the signal disruption element 24 to be manually flipped from behind the mounting element 25 by a user to cover the corresponding RFID tag 230. When the signal disruption element 24 is positioned behind the mounting element 25, the corresponding RFID tag is exposed and therefore may receive incoming RFID signal 99A from the at least one reader 210, process said signal, and transmit a response signal 99X to the reader(s), thereby allowing detection of the tag 230 by the reader(s) 210. When the signal disruption element 24 is positioned to effectively cover the corresponding RFID tag 230, the tag is thus prevented from receiving RFID signal 99A and transmitting response signal 99X to the reader(s). As such, a user of the embodiment of FIGS. 5A-5D may turn “off” and “on” each of the three RFID tags comprising the embodiment by covering and uncovering the respective RFID tag 230 by positioning the signal disruption element 24 accordingly to achieve a desired predetermined code pattern or configuration as to the detectability of each of the three RFID tags of the embodiment. In addition, the positioning of said signal disruption elements 24, singly or in various combinations, provides visual cues to individuals as to the nature of the intended communication using the system (see FIG. 6).

In FIG. 5A, the signal disruption elements 24 of first RFID tag 230A, second RFID tag 230B and third RFID tag 230C are all positioned behind the mounting element 25, thereby allowing all three (3) RFID tags to receive incoming RFID signal(s) 99A transmitted from the at least one reader 210 and, in response thereto, transmit response signals 99X to be received/detected by said reader(s) 210. Each of the three (3) tags, therefore, is visible and detectable to the at least one reader 210 (and visually visible to any individuals within eyesight of the tags 230). In FIG. 5B, however, the signal disruption element 24 of first RFID tag 230A is positioned to cover its corresponding tag 230A, thereby preventing first tag 230A from transmitting a response signal 99X. Second RFID tag 230B and third RFID tag 230C remain uncovered and continue to transmit their respective response signals 99X. In FIG. 5C, the signal disruption element 24 of second RFID tag 230B is positioned to cover its corresponding tag 230B, thereby preventing second tag 230B from transmitting a response signal 99X. In this configuration, first RFID tag 230A and third RFID tag 230C are uncovered and continue to transmit their respective response signals 99X. Lastly, in In FIG. 5D, the signal disruption element 24 of third RFID tag 230C is positioned to cover its corresponding tag 230C, thereby preventing third RFID tag 230C from transmitting a response signal 99X. In this particular configuration, first RFID tag 230A and second RFID tag 230B are uncovered and continue to transmit their respective response signals 99X. While the various configurations of FIGS. 5B-5D depict only one (1) of the three (3) RFID tags of the embodiment covered or blocked by its respective signal disruption element 24 at a time, two or more of the respective signal disruption elements 24 may be manipulated to cover or block the corresponding RFID tags 230, thereby allowing for further combinations or configurations of the three (3) tag system of FIGS. 5A-5D. Moreover, while the embodiment of FIGS. 5A-5D depicts a three tag system, it is understood that any number of RFID tags may be utilized. For example, referring to FIGS. 2-3, a twelve (12) RFID tag system is depicted. The invention allows for no limit to the number (or types) of RFID tags that may be utilized.

In addition, it is understood that positioning a signal disruption element 24 over an RFID tag 230 may be accomplished via manual manipulation or it may be remotely controlled. Positioning a signal disruption element 24 is not limited to any specific means or methods. In addition, words, numbers, symbols, phrases and other human readable graphics may be applied to signal disruption elements 24, thereby presenting additional visual cues and messages to and for individuals within eyesight of the RFID tags 230 as to the message or communication associated therewith.

The 3-tag RFID embodiment of FIGS. 5A-5D depicts the at least one signal disruption element 24 covering only one RFID tag 230 at a time. In embodiments, multiple signal disruption elements 24 may cover more than one RFID 230 simultaneously. Alternatively, a signal disruption element 24 may be configured of sufficient size and dimension to effectively cover two or more tags 230 simultaneously and disrupt the signals with respect to each RFID tag 230 covered. For example, and not by way of limitation, a 4-tag system may comprise a signal disruption element 24 that is of sufficient size and dimension to effectively cover two (2) tags simultaneously and may be attached to the mounting element 25 by way of a sliding means, thereby allowing a user to manipulate or position the signal disruption element 24 to cover, simultaneously, tags 1-2, tags 2-3 or tags 3-4. Utilizing a multiple tag signal disruption element 24 in a multi-tag system provides additional validation and cross checking within the system.

FIG. 6 depicts various configurations of the embodiment of FIGS. 5A-5D and hypothetical illustrative communications corresponding to each such configuration as predetermined by users of the system and pre-programmed for use by the at least one network server(s) 310, 320 (including within any databases comprising same for immediate access by the software/logic in operation in the at least one network server(s) 310, 320) that communicates the corresponding communication to the human interface device for receipt and access by users of the system. In the three (3) tag embodiment of FIGS. 5A-5D, eight (8) different configurations are possible:
Configuration 1: All three RFID tags transmit their respective signals 99X (and the unique code X of each such RFID tag);
Configuration 2: Second tag 230B and third tag 230C transmit their respective signals 99X (and the unique code X of each such RFID tag); signals 99A and 99X with respect to first tag 230A are disrupted/blocked;
Configuration 3: First tag 230A and third tag 230C transmit signals 99X (and the unique code X of each such RFID tag); signals 99A and 99X with respect to second tag 230B are disrupted/blocked;
Configuration 4: First tag 230A and second tag 230B transmit their respective signals 99X (and the unique code X of each such RFID tag); signals 99A and 99X with respect to third tag 230C are disrupted/blocked;
Configuration 5: Only third tag 230C transmits its respective signal 99X (and its unique code X); signals 99A and 99X with respect to first tag 230A and second tag 230B are disrupted/blocked;
Configuration 6: Only first tag 230A transmits its respective signal 99X (and its unique code X); signals 99A and 99X with respect to second tag 230B and third tag 230C are disrupted/blocked;
Configuration 7: Only second tag 230B transmits its respective signal 99X; signals 99A and 99X with respect to first tag 230A and third tag 230C are disrupted; and
Configuration 8: Signals 99A and 99X with respect to all three tags are disrupted/blocked.

The embodiment depicted by the configurations of FIG. 6 is but one example and is not limiting of the invention or various embodiments thereof. It is expressly understood that the disclosed invention covers multiple embodiments. For example, a 3-tag embodiment utilizing a single sliding signal disruption element 24 that effectively covers only one tag at a time, as that depicted in FIGS. 4B-4C (thereby only disrupting or blocking signals 99A, 99X of the tag covered and no other tags) would provide for a different combination of configurations than that of FIG. 6, which would be readily appreciated by one skilled in the art. In yet another embodiment of a three-tag system as that under consideration in FIG. 6 comprising a signal disruption element 24 that effectively covers two (2) RFID tags 230 simultaneously, a much different combination configuration would result than that expressly set forth in FIG. 6, which, again, would be readily appreciated by one skilled in the art. There are no limitations to the number of RFID tags 230, number of signal disruption elements 24 or number of tags that a single tag signal disruption element 24 may effectively block with the invention. The invention is specifically meant to cover all combinations and possibilities and the particular examples (embodiments) disclosed herein are just that: examples of embodiments of the invention.

Based on the forgoing configurations, the predetermined communication messages programmed for access, processing and transmission by the at least one network server 310, 320 (which may be stored in databases accessible by the software/logic in operation on the at least one network server(s) 310, 320) are transmitted via a data/communication network 302 to at least one human interface device for receipt and processing by users of the system. FIG. 6 depicts such communication examples using the readiness of an order for pick-up and shipment as the subject matter for the eight (8) possible configurations of the three tag system. However, as noted throughout this disclosure, the identification codes X of each of the tags 230 of any embodiment of the invention may be pre-determined by users of the RFID system (and programmed or entered into database(s) comprising the at least one network server(s) 310, 320 by users of the system) to mean any desired indicia and coded accordingly. As such, as discussed with respect to the various embodiments of the invention, the presence of one or more RFID tags 230, including various combinations of RFID tags 230, detected or read simultaneously by an at least one reader(s) 210 may be “decoded” or interpreted by the logic or software of the system to mean any number of quantitative or qualitative indicia based on predetermined criteria established for the RFID system by the users thereof. In addition, users of the RFID communication system may change such preprogrammed indicia based on circumstances and according to users' specific needs. Such programming or entry of specific messages or indicia may be readily accomplished by users of the system through any interface device 330 connected to the system via the data/communication network 302. One skilled in the art will recognize that the RFID system described herein, including its various components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of the more general classes. In general, use of any specific exemplar is intended to be representative of its class, and the non-inclusion of specific components (e.g., operations), devices, and objects should not be taken as limiting.

In other applications, various embodiments of the RFID communication system disclosed herein may alert quantitative and qualitative information about a product or a product's environment (as opposed to, for example, whether an order for a product shipment is ready for pick-up). For illustrative purposes, the communication system may provide various information regarding a rose bush. The detection of the unique identification codes X of one or more RFID tags 230 in various configurations may thus alert the following information or messages to users of an embodiment:
Status (the rose bush is 1 foot tall; the rose bush is 2 feet tall, the rose bush is 3 feet tall);
State (the rose bush is dead; the rose bush is alive);
Maturity (the rose bush has no buds yet; few buds; is fully budding; has blossoms);
Readiness (the rose bush has not been packed for shipment; the rose bush has been packed for shipment; rose bush is ready for pick up);
Predetermined objective has been met or failed (rose bush has been watered; rose bush has not been watered; or the temperature in a zone is acceptable or not acceptable);
Multiple choices: rose bush is blooming white, or pink, or red

In yet other applications, various embodiments of the RFID communication systems disclosed herein may alert that the first step of a two-step process has been completed or not completed; or stage two of a four-stage process has been reached.

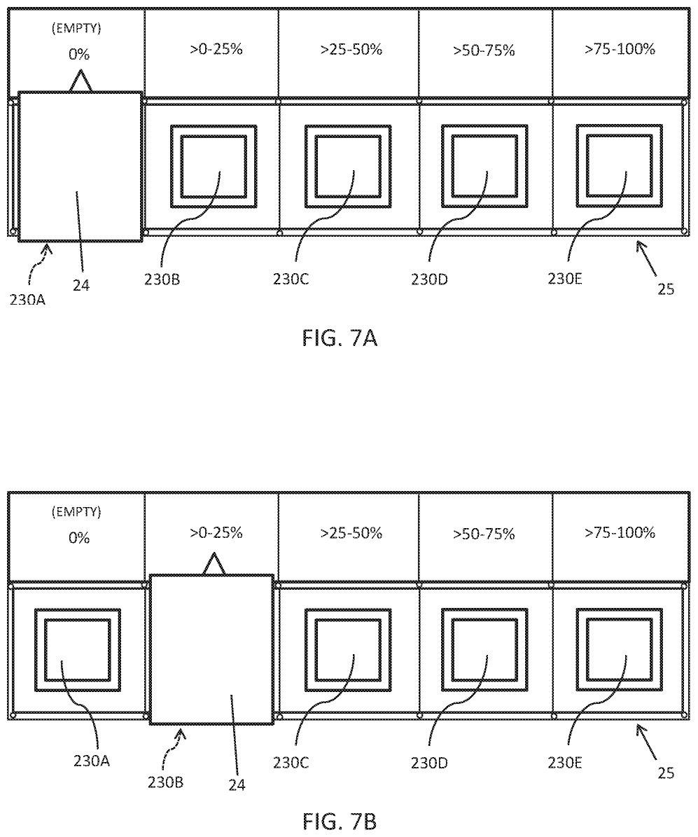

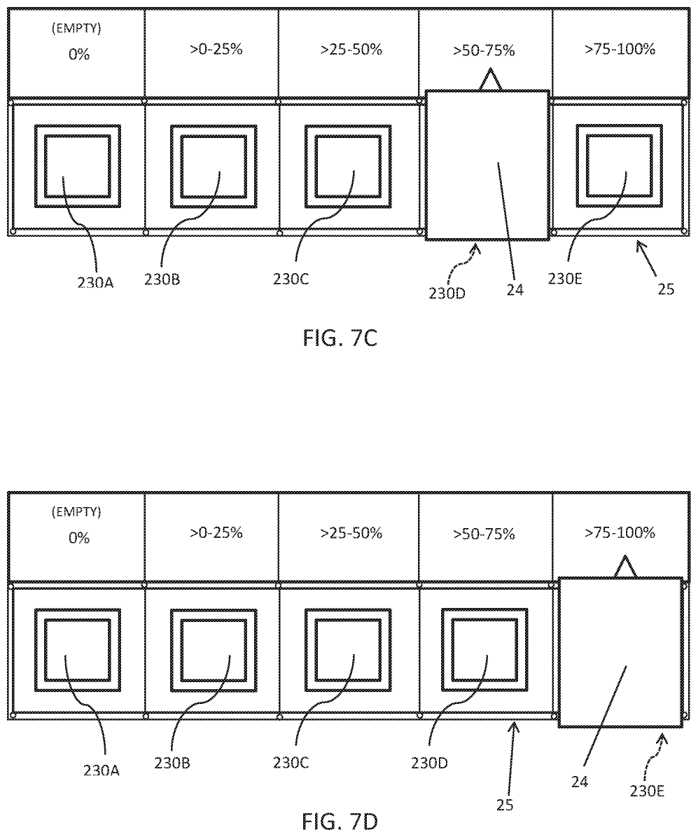

In yet another application, embodiments of the RFID communication systems disclosed herein may directed to an inventory management system, such as (but not limited to) a KanBan system. An example of such an inventory management embodiment comprises five (5) RFID tags and a sliding signal disruption element 24 that is manipulated or positioned by users of the system to indicate various levels of inventory of product or goods within a particular zone. In a five (5) tag system, the predetermined inventory levels associated with the specific RFID tag covered by the sliding signal disruption element 24 may be as follows: 0 (zero or empty), >0-25%, >25-50%, >50-75%, >75-100%. The embodiment described herein is depicted in FIGS. 7A-7D. In the embodiment of FIGS. 7A-7D, the sliding signal disruption element 24 is manually positioned by users of the system to not only cover the respective RFID tag associated with the level of inventory (thereby blocking the signals to and/or from that tag), but the embodiment comprises a visual cue or signal to users within eyesight for immediate reference. Moreover, the visual cues depicted in the embodiment of FIGS. 7A-7D comprise graphical representation of the message communicated—with words, numbers and symbols in human readable format—thereby providing the required information to users to allow the positioning of the signal disruption element 24 over the appropriate RFID tag 230 representing the respective inventory level. In this respect, the embodiment is a multi-faceted communication device using RFID signals, visual cues and graphic signaling.

Referring to the embodiment of FIGS. 7A-7D, in FIG. 7A, the sliding signal disruption element 24 is manually (or electronically, including via remote command) positioned over first RFID tag 230A when the level of inventory is 0% (zero) or empty. When positioned over first RFID tag 230A, the sliding signal disruption element 24 provides a visual cue to users and the various RFID tags comprising the embodiment have been predetermined as described above to reflect the disruption of signals to/from RFID tag 230A to be interpreted by the system to mean 0% (zero) or empty inventory. In FIG. 7B, the sliding signal disruption element 24 is positioned over second RFID tag 230B when the inventory level is in the range of >0-25%. When positioned over second RFID tag 230B, the sliding signal disruption element 24 provides a visual cue to users and the various RFID tags comprising the embodiment have been predetermined as described above to reflect the disruption of signals to/from RFID tag 230B to be interpreted by the system to mean inventory is in the range of >0-25%. In FIG. 7C, the sliding signal disruption element 24 is positioned over fourth RFID tag 230D when the level of inventory is in the range of >50-75%. When positioned over fourth RFID tag 230D, the sliding signal disruption element 24 provides a visual cue to users and the various RFID tags comprising the embodiment have been predetermined as described above to reflect the disruption of signals to/from RFID tag 230D to be interpreted by the system to mean inventory is in the range of >50-75%. Lastly, in FIG. 7D, the sliding signal disruption element 24 is positioned over fifth RFID tag 230E when inventory is in the range of >75-100%. When positioned over fifth RFID tag 230E, the sliding signal disruption element 24 provides a visual cue to users and the various RFID tags comprising the embodiment have been predetermined as described above to reflect the disruption of signals to/from RFID tag 230E to be interpreted by the system to mean inventory is in the range of >75-100%. For purposes of brevity, FIGS. 7A-7D, do not depict the sliding signal disruption signal element positioned over third RFID tag 230C, although users may so position it to reflect inventory levels in the range of >25-50%.

In another application, RFID tags 230A, 230B, 230C may alert that step one of three has been completed or not completed; or that step two of three has been competed or not completed; or that step three of three has been completed or not completed.

As is readily apparent, embodiments of the communication systems disclosed herein may be adapted to almost unlimited scenarios. It is understood that the embodiments of the communication systems disclosed herein are not limited to any specific adaptation.

The methods and systems described herein may be deployed in part or in whole through a machine (i.e., the at least one network server(s) 310, 320) that executes computer software, program codes, and/or instructions on a processor. The predetermined messages, instructions, data, etc. corresponding the detection or non-detection of specific RFID tags 230 are entered by users of the system via interface devices 330 of the system and stored within a memory or a database accessible by the at least one network server(s) 310, 320 and compared with the signal codes X received by the server(s) from the at least one reader 210 based on its detection of response signal(s) 99X of RFID tags 230. Alternatively, the execution or operation of such software, program codes, logic and/or instructions may be performed in reader 210 that has been modified to process such software, program codes, logic and/or instructions and access for processing in accordance herewith the pre-programmed data entered by users and stored within memory and/or database(s) either in the reader 210 or the at least one network server(s) 310, 320. For example, reader 210 may comprise a CPU, a memory and/or a data storage (database storage) to allow reader 210 to further function as the at least one network server, whereby such reader/network server may further communicate via a network connection (as described above) with additional network servers 310, 320. Alternatively, the combination reader/server 210 may also communicate via a communication/data network 302 connection (as described above) with the at least one human interface device 330.

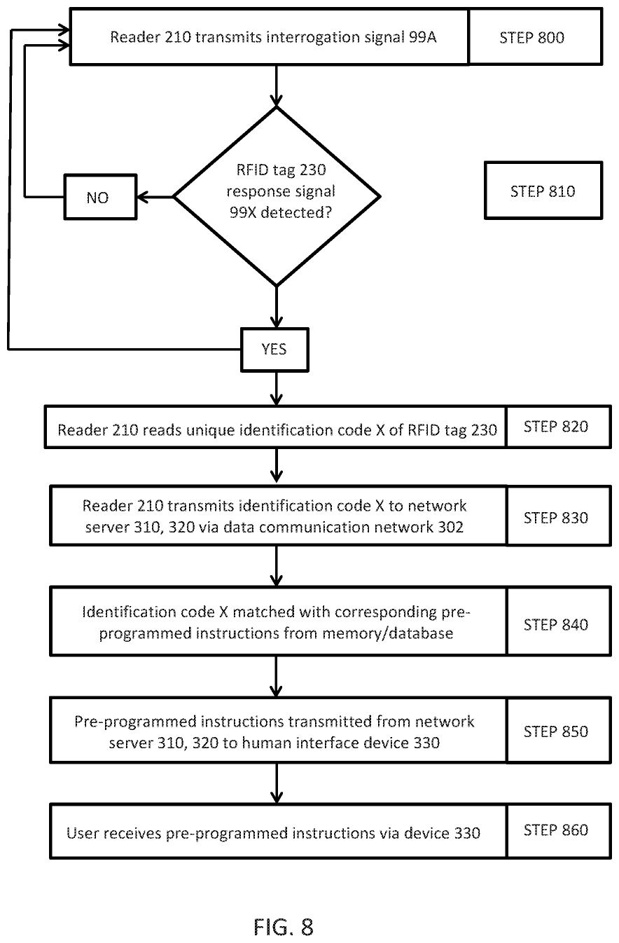

FIG. 8 is a schematic flow chart depicting a process implemented by an embodiment of the invention as further described with respect to the drawings of various embodiments. It is understood that the process of FIG. 8 may be readily adapted to the various embodiments of the system depicted in the drawings and further disclosed herein. At step 800, the reader 210 transmits an interrogation signal 99X within a zone. In response to receipt of interrogation signal 99A, at least one RFID tag(s) within the zone transmits a response signal 99X. At step 810, if no response signal 99X is detected by the reader 210, the reader 210 continues to transmit its interrogation signal 99A. If a response signal 99X is detected by the reader 210, the process proceeds to step 820. However, regardless of whether one or more response signals 99X are detected by the reader 210, the at least one reader 210 continues to transmit interrogation signal 99A to search for and detect RFID tags 230 that may enter the zone or that may made accessible for detection by removal of signal disruption element(s) 24 that had previously blocked or prevented detection. At step 820, the at least one reader 210 reads the unique identification code X of each such RFID tag(s) 230 so detected by the reader(s) 210. Upon reading the unique identification code X of each RFID tag 230 detected, at step 830 the at least one reader 210 transmits said unique identification code(s) X to the at least one network server(s) 310, 320 via data communication network 302. At step 840, software or programmed logic operating on the at least one network server(s) 310, 320 reads the unique identification code(s) X received from the reader(s) 210 and searches a preprogrammed database of unique identification code(s) with their corresponding sets of data, instructions, messages, etc. for match. If the at least one network server(s) 310, 320 fails to find a match of the unique identification code X in the preprogrammed database, no action is taken by said network server(s). At step 850, if the software or programmed logic operating on the at least one network server(s) 310, 320 matches the unique identification code(s) X received from the reader(s) 210 with its corresponding unique identification code(s) in the preprogrammed database, the network server(s) forwards the instructions, data, message, alert, etc. associated with the unique identification code(s) to the at least one human interface device 330 via the data communication network 302. At step 860, a user of the system receives the instructions, data, message, alert, etc. though the interface device 330, thereby delivering the intended communication to the user(s).

While the invention has been disclosed in connection with embodiments shown and described in detail, various modifications and improvements thereon will become readily apparent to those skilled in the art. Accordingly, the spirit and scope of the present invention is not to be limited by the foregoing examples but is to be understood in the broadest sense allowable by law.

This disclosure of the various embodiments of the invention, with accompanying drawings, is neither intended nor should it be construed as being representative of the full extent and scope of the present invention. The images in the drawings are simplified for illustrative purposes and are not necessarily depicted to scale. To facilitate understanding, identical reference terms are used, where possible, to designate substantially identical elements that are common to the figures, except that suffixes may be added, when appropriate, to differentiate such elements.

Although the invention herein has been described with reference to particular illustrative embodiments thereof, it is to be understood that these embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

1. An RFID communication system, comprising:
an at least one RFID reader capable of transmitting an RFID interrogation signal and receiving one or more RFID tag response signals thereto within an area;
an at least one RFID tag in the area comprising a unique identifier and further capable of receiving the RFID interrogation signal transmitted from the RFID reader and transmitting a response RFID signal thereto;
an at least one network server connected to the RFID reader via a data communication network, said network server further comprising a database of pre-programmed data corresponding to the unique identifier of the RFID tag and a software operating thereon capable of searching said database for the unique identifier of the RFID tag and the pre-programmed data corresponding therewith; and
an at least one human interface device connected via the data communication network to the network server,
wherein in response to receiving the RFID interrogation signal transmitted by the RFID reader, the RFID tag transmits the response RFID signal thereto for receipt by the RFID reader, said response signal comprising the unique identifier of the RFID tag, thereby resulting in a detection of the unique identifier of the RFID tag by the RFID reader upon receipt of the RFID response signal;
wherein upon detection of the RFID tag's unique identifier, the RFID reader transmits via the data communication network the unique identifier to the network server; and
wherein upon receipt of the unique identifier by the network server, the software operating thereon searches the database and matches said identifier with its corresponding pre-programmed data and transmits the pre-programmed data via the data communication network to the human interface device for receipt by an at least one user of the system.

2. The communication system of claim 1, further comprising an at least one RFID signal disruption element for positioning about the RFID tag, wherein when appropriately positioned about the RFID tag, the RFID signal disruption element prevents the RFID tag from receiving the RFID interrogation signal transmitted by the RFID reader, thereby preventing said RFID tag from transmitting its response RFID signal thereto and resulting in a non-detection of the unique identifier of the RFID tag by the RFID reader.

3. The communication system of claim 2, wherein the database is further comprised of pre-programmed data corresponding to the non-detection by the RFID reader of the unique identifier of the RFID tag.

4. The communication system of claim 3, wherein the pre-programmed data corresponding to the non-detection of the unique RFID identifier is transmitted by the network server to the user via the data communication network.

5. The communication system of claim 1 wherein the RFID tag is passive.

6. The communication system of claim 1, wherein the network server is further comprised of a CPU, a memory and a storage.

7. The communication system of claim 3, wherein the pre-programmed data is entered into the database by the user of the system via the interface device.

8. The communication system of claim 7, wherein the pre-programmed data may be amended by the user of the system.

9. The communication system of claim 3, wherein the RFID tag and the RFID signal disruption element provide a visual cue to the user of the system of the pre-programmed data corresponding to the detection and the non-detection of the unique identifier of the RFID tag.

10. The communication system of claim 3, further comprising a plurality of RFID tags detachably attached to an attachment element wherein when attached to the attachment element said RFID tags are adjacent to each other.

11. The communication system of claim 10, wherein the RFID signal disruption element is detachably attached to the attachment element and may be positioned by the user of the system to prevent one or more of the RFID tags from receiving the RFID interrogation signal.

12. The communication system of claim 11, further comprising a plurality of signal disruption elements.

13. The communication system of claim 12, wherein the detected unique identifiers received by the network server and the non-detected unique identifiers received by the network server comprises a unique combination of detected and non-detected unique identifiers.

14. The communication system of claim 13, wherein the database is further comprised of pre-programmed data corresponding to the unique combination of detected and non-detected unique identifiers.

15. The communication system of claim 14, wherein the RFID tags and the RFID signal disruption elements comprising the unique combination of detected and non-detected unique identifiers provide a visual cue to the user of the system of the pre-programmed data corresponding to the unique combination.

16. The communication system of claim 13, wherein the number of RFID signal disruption elements is equal to the number of RFID tags.

17. The communication system of claim 1, wherein the data communication network is wireless.
